(19) United States
(12) Patent Application Publication
(10) Pub. No.: US 2008/0167959 A1
(43) Pub. Date: Jul. 10, 2008

(54) System and Method for Enhanced Content Distribution

(75) Inventor: Robert C. Lovell, Leesburg, VA (US)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Chantilly, VA (US)

(21) Appl. No.: 11/969,547

(22) Filed: Jan. 4, 2008

Related U.S. Application Data
(60) Provisional application No. 60/878,394, filed on Jan. 4, 2007.

(51) Int. Cl. G06Q 30/00; H04Q 7/20

(52) U.S. Cl. 705/14; 455/456.3

(57) ABSTRACT

An infrastructure that supports, facilitates, etc., in new and creative ways, the enhanced distribution of the myriad forms of content (which might include, possibly inter alia, news items, traffic alerts, weather notices, travel advisories, stock quotations, advertisements, coupons, educational factoids, etc.) within established wireless messaging paradigms such as, possibly inter alia, Multimedia Message Service, Wireless Application Protocol, IP Multimedia Subsystem, etc. The service may optionally leverage the capabilities of a centrally-located Messaging Inter-Carrier Vendor.

This application claims the benefit of U.S. Provisional Patent Application No. 60/878,394, filed on Jan. 4, 2007, which is herein incorporated by reference in its entirety.

### BACKGROUND

1. Field of the Invention

The present invention relates generally to telecommunications services. More particularly, the present invention relates to capabilities that enhance substantially the value and usefulness of various messaging paradigms including, inter alia, Short Message Service (SMS), Multimedia Message Service (MMS), Internet Protocol (IP) Multimedia Subsystem (IMS), Wireless Application Protocol (WAP), etc.

2. Background of the Invention

As the ‘wireless revolution’ continues to march forward the importance to a Mobile Subscriber (MS)—for example a user of a Wireless Device (WD) such as, inter alia, a mobile telephone, a BlackBerry, etc. that is serviced by a Wireless Carrier (WC)—of their WD grows substantially. One consequence of such a growing importance is the resulting ubiquitous nature of WDs—i.e., MSs carry them at almost all times and use them for an ever-increasing range of activities.

As MSs employ their WDs for ever more activities their WDs become, among other things, increasingly more valuable to Content Providers (CPs) as a vehicle to enhance the distribution of their content (which might include, possibly inter alia, news items, traffic alerts, weather notices, travel advisories, stock quotations, advertisements, coupons, educational factoids, etc.).

Consequently the need exists for an infrastructure that can seamlessly leverage the full universe of WDs to support, facilitate, etc., in new and creative ways, the enhanced distribution of the myriad forms of content.

The present invention provides such enhanced content distribution capabilities and addresses various of the (not insubstantial) challenges that are associated with same.

### SUMMARY OF THE INVENTION

In one embodiment of the present invention, there is provided a method for distributing content within a wireless ecosystem. The method involves receiving an incoming message from a mobile subscriber, where the incoming message is responsive to content viewed by the mobile subscriber. The location of the mobile subscriber is ascertained (by, e.g., global positioning, cell tower proximity, etc.) and one or more processing steps are performed on the incoming message using, at least in part, information previously supplied by the mobile subscriber and the location of the mobile subscriber. Thereafter, the method provides for generating and dispatching to the mobile subscriber one or more outgoing messages based, at least in part, on the location of the mobile subscriber and content associated with the location of said mobile subscriber.

The incoming or outgoing message may be one or more of (a) a short message service message, (b) a multimedia message service message, and/or (c) an IP multimedia subsystem message. The outgoing message may contain one or more of (a) informational text, (b) an advertisement, (c) a coupon, and/or (d) content

One feature of embodiments of the invention is that the viewed content is dynamically changing content, and that the dynamically changing content may be changed based, at least in part, on characteristics of other mobile subscribers at the same location as the location of said mobile subscriber.

Still further in accordance with an embodiment of the present invention the method includes receiving confirmation that the mobile subscriber acted upon contents of the outgoing message, performing one or more processing steps on the received confirmation, including at least updating a tracking repository, and generating and dispatching to the mobile subscriber one or more update messages. The tracking repository may maintain, for each mobile subscriber, counts of one or more of accumulated (a) points, (b) credits, and/or (c) money, and the update message may be one or more of (a) a short message service message, (b) a multimedia message service message, and/or (c) an IP multimedia subsystem message.

Other features of a method of the present invention include receiving a redemption request from the mobile subscriber, performing one or more processing steps on the received redemption request including at least the updating of the tracking repository, and redeeming some portion of accumulated value to the mobile subscriber based at least in part on counts belonging to the mobile subscriber in said tracking repository. Redemption may take place through one or more of (a) a wireless carrier, (b) a world wide web site, (c) electronic mail, and/or (d) postal mail.

The previously supplied information may be defined by a mobile subscriber during a registration process, and may include one or more of Identifying Information, Notification Information, Billing Information, and Preference Information. This information may be preserved through a User Profile. In one possible implementation, the registration process is Web-based, and may include a billing component.

In another embodiment of the present invention, a method for interacting with wireless mobile subscribers is provided. The method includes receiving a first message from a first mobile subscriber, determining that the first mobile subscriber is present at a predetermined venue, delivering first content from a content provider to the first mobile subscriber, wherein the first content is associated with the predetermined venue, receiving a reply message from the first mobile subscriber in response to the first content, receiving a second message from a second mobile subscriber, determining that the second mobile subscriber is also present at the predetermined venue, delivering second content from the content provider to the second mobile subscriber, wherein the second content is different from the first content and is selected based, at least in part, on contents of the reply message from the first mobile subscriber.

Further in accordance with this embodiment, content may be selected based on information previously received during a registration process from both the first and the second mobile subscribers.

The content provider may further be contacted as a result of the reply message and the second message from the second mobile subscriber.

Also, the first and the second content may be delivered at a moment in time that coincides with a time of a predetermined event at the predetermined venue.

These and other features of the embodiments of the present invention, along with their attendant advantages, will be more fully appreciated upon a reading of the following detailed description in conjunction with the associated drawings.

### BRIEF DESCRIPTION OF THE DRAWINGS

FIG. 1 is a diagrammatic presentation of an exemplary Messaging Inter-Carrier Vendor (MICV).

FIG. 2 illustrates one particular arrangement that is possible through aspects of the present invention.

FIG. 3 illustrates various of the exchanges or interactions that are possible during the optional registration portion of the present invention.

FIG. 4 illustrates various of the exchanges or interactions that are supported by aspects of the present invention.

FIG. 5 is a diagrammatic presentation of aspects of an exemplary Service Provider (SP) Application Server (AS).

It should be understood that these figures depict embodiments of the invention. Variations of these embodiments will be apparent to persons skilled in the relevant art(s) based on the teachings contained herein.

### DETAILED DESCRIPTION

The present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same. The disclosure of U.S. Pat. No. 7,154,901, along with its associated continuations, is incorporated herein by reference.

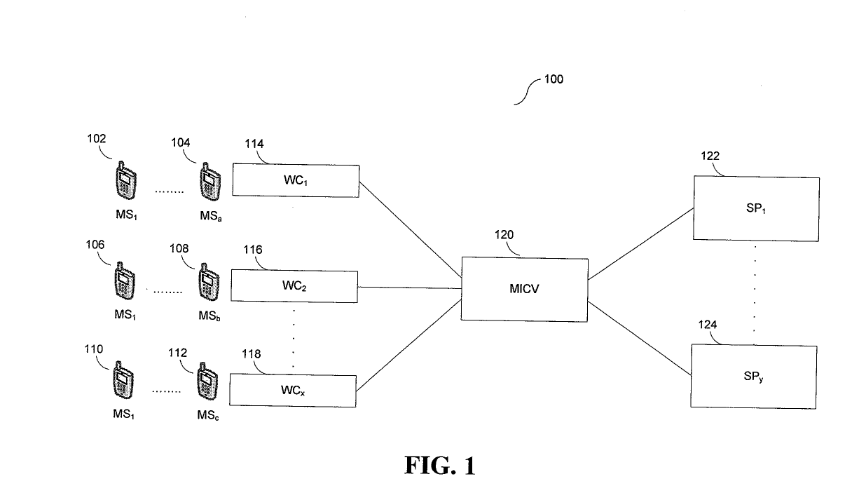

As illustrated in FIG. 1 and reference numeral 100 a MICV 120 is disposed between, possibly inter alia, multiple WCs (WC₁ 114→WCₓ 118) on one side and multiple SPs (SP₁ 122→SP_{y} 124) on the other side and thus ‘bridges’ all of the connected entities. A MICV 120 thus, as one simple example, may offer various routing, formatting, delivery, value-add, etc. capabilities that provide, possibly inter alia:

1) A WC 114→118 (and, by extension, all of the MSs 102→104, 106→108, and 110→112 that are serviced by the WC 114→118) with ubiquitous access to a broad universe of SPs 122→124 and

2) A SP 122→124 with ubiquitous access to a broad universe of WCs 114 →118 (and, by extension, all of the MSs 102→104, 106→108, and 110→112 that are serviced by the WC 114→118).

Generally speaking a MICV may have varying degrees of visibility (e.g., access, etc.) to the (MS←→MS, MS←→SP, etc.) messaging traffic:

1) A WC may elect to route just their out-of-network messaging traffic to a MICV. Under this approach the MICV would have visibility (e.g., access, etc.) to just the portion of the WC's messaging traffic that was directed to the MICV by the WC.

2) A WC may elect to route all of their messaging traffic to a MICV. The MICV may, possibly among other things, subsequently return to the WC that portion of the messaging traffic that belongs to (i.e., that is destined for a MS of) the WC. Under this approach the MICV would have visibility (e.g., access, etc.) to all of the WC's messaging traffic.

While the discussion below will include a MICV it will be readily apparent to one of ordinary skill in the relevant art that other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a MICV, multiple third-party entities working together, etc.

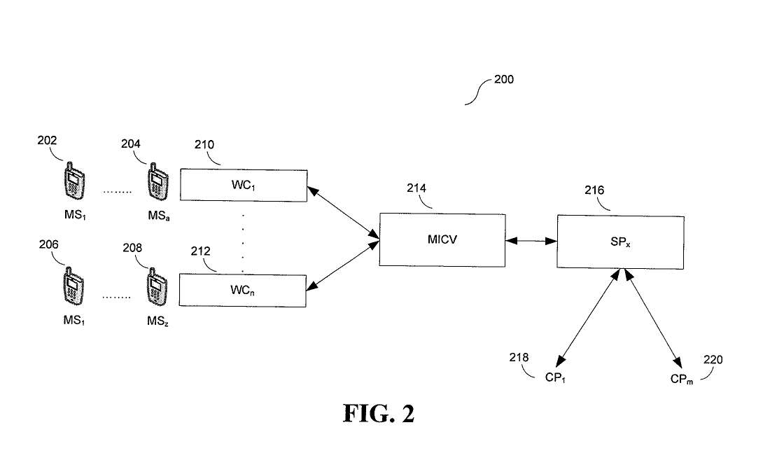

To help explain key aspects of the present invention consider the illustrative example that is depicted through FIG. 2 and the narrative below.

As indicated in FIG. 2 and reference numeral 200 all of the messaging traffic of numerous WCs (WC₁ 210→WCₙ 212) is exchanged with a MICV 214 and the MICV 214 is connected with SPₓ 216 (a SP that offers, possibly inter alia, the present invention). Additionally SPₓ 216 is connected with numerous CPs (CP₁ 218 →CPₘ 220) such that, possibly inter alia and as described in detail below, a CP (e.g., CP₁ 218→CPₘ 220) may provide content/information/etc. to SPₓ 216 and SPₓ 216 may provide data/information/etc. to a CP (e.g., CP₁ 218→CPₘ 220).

Within the framework that is illustrated by FIG. 2 SPₓ 216 may offer an optional registration process. During such a process a party, for example (possibly inter alia) a MS or a representative of a CP, that is interested in using aspects of the present invention may identify themselves and provide some range of information. A registration process may be tailored (e.g., the range of information gathered, the scope of access subsequently granted, etc.) to the class of user—e.g., a MS may complete one type of registration process, a representative of a CP may complete another type of registration process, etc.

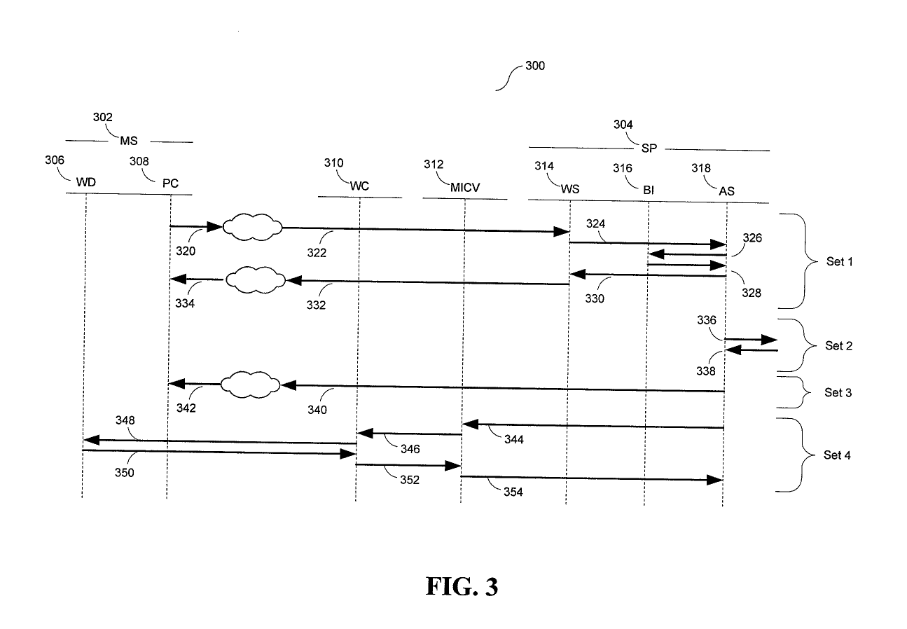

FIG. 3 and reference numeral 300 illustrate various of the exchanges or interactions that might occur during an illustrative registration process (involving a hypothetical MS 302, Mary, and a our hypothetical SP 304, SPₓ). Of interest and note in the diagram are the following entities:

MS 302 WD 306. For example, Mary's 302 WD such as a cellular telephone, BlackBerry, PalmPilot, etc.

MS 302 Personal Computer (PC) 308. For example, one of Mary's 302 work, home, etc. PCs.

WC 310. The provider of service for Mary's 302 WD 306.

MICV 312. As noted above the use of a MICV, although not required, provides significant advantages.

SP 304 Web Server (WS) 314. A publicly-available World Wide Web (WWW) site that is optionally provided by SPₓ 304.

SP 304 Billing Interface (BI) 316. A single, consolidated interface that SPₓ 304 may use to easily reach, inter alia, one or more external entities such as a credit card or debit card clearinghouse, a carrier billing system, a service bureau that provides access to multiple carrier billing systems, etc.

SP 304 AS 318. Facilities that provide key elements of the instant invention (which will be further described below).

It is important to note that while in FIG. 3 the MS 302 WD 306 and MS 302 PC 308 entities are illustrated as being adjacent or otherwise near each other in actual practice the entities may, for example, be physically located anywhere.

In the discussion to follow reference is made to messages that are sent, for example, between a MS 302 and an SP 304. As set forth below, a given “message” sent between a MS 302 and a SP 304 may actually comprise a series of steps in which the message is received, forwarded and routed between different entities, including a WD 306 associated with a MS 302, a WC 310, a MICV 312, and a SP 304. Thus, unless otherwise indicated, it will be understood that reference to a particular message generally includes that particular message as conveyed at any stage between an origination source, such as a WD 306 of a MS 302, and an end receiver, such as a SP 304. As such, reference to a particular message generally includes a series of related communications between, for example, a MS 302 and a WC 310, the WC 310 and a MICV 312, and the MICV 312 and a SP 304. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

In FIG. 3 the exchanges that are collected under the designation Set 1 represent the activities that might take place as Mary 302 begins an optional registration process with SPₓ 304. For example:

A) Mary 302 uses one of her PCs 308 to visit a WS 314 of SPₓ 304 to, possibly among other things, complete a service registration process (see 320→322).

B) The WS 314 of SPₓ 304 interacts with an AS 318 of SPₓ 304 to, possibly among other things, commit some or all of the information that Mary 302 provided to a data repository (e.g., a database), optionally complete a billing transaction, etc. (see 324).

C) As appropriate and as required a BI 316 completes a billing transaction in conjunction with AS 318 (see 326→328).

D) The WS 314 responds appropriately (e.g., with the presentation of a confirmation message, etc.) (see 332→334) upon, e.g., an indication (320) from AS 318.

The specific exchanges that were described above (as residing under the designation Set 1) are illustrative only and it will be readily apparent to one of ordinary skill in the relevant art that numerous other exchanges are easily possible and indeed are fully within the scope of the present invention. For example, the collected information may be reviewed, confirmed, etc. through one or more manual and/or automatic mechanisms. For example, the registration process may be completed through any combination of one or more channels including, inter alia, the indicated WWW facility, wireless messaging (SMS, MMS, IMS, etc.), E-mail messages, Instant Messaging (IM) exchanges, conventional mail, telephone, Interactive Voice Response (IVR) facilities, etc.

During the registration process that was described above a range of information may be captured from a candidate user including, inter alia:

1) Identifying Information (e.g., general information about Mary). For example, possibly among other things, a unique identifier and a password, optionally a pseudonym or handle, name, classification (e.g., such as, inter alia, representative of a corporation, etc.), age, sex, etc.

2) Notification Information. For example, optional contact information (such as, inter alia, landline and/or wireless Telephone Numbers [TNs], E-mail addresses, IM addresses, physical addresses, etc.).

3) Billing Information. Different service billing models may be offered by SPₓ including, possibly inter alia, free (e.g., possibly advertising-based), a fixed one-time charge, a recurring (hourly, daily, monthly, etc.) fixed charge, a recurring (hourly, daily, monthly, etc.) variable charge, a per-use charge, etc. Different payment mechanisms may be supported by SPₓ including, possibly among other things, credit or debit card information, authorization to place a charge on a MS's phone bill, etc.

4) Preference Information. Any number of optional items including, as simple examples, likes and dislikes (e.g., colors, foods, religion, politics, movies, music, books, TV shows, clothing, automobiles, etc.); census-like data (e.g., household makeup, salary, recent purchases, planned purchases, family history, etc.); etc.

5) Other Information. Additional, possibly optional, information.

The specific pieces of information that were described above are illustrative only and it will be readily apparent to one of ordinary skill in the relevant art that numerous other pieces of information (e.g., additional Preference Information, scheduled daily/weekly/etc. reporting that may be desired, etc.) are easily possible and indeed are fully within the scope of the present invention.

As noted above the information that Mary provided during the registration process may be preserved in a data repository (e.g., a database) and may optionally be organized as a MS Profile.

The content of Mary's profile may optionally be augmented by SPₓ. For example, one or more internal or external sources of consumer, demographic, geographic, psychographic, corporate, etc. information may be leveraged to selectively enhance or augment elements of Mary's profile.

As noted above, a SP's BI may optionally complete one or more billing transactions. A billing transaction may take any number of forms and may involve different external entities (e.g., a WC's billing system, a carrier billing system service bureau, a credit or debit card clearinghouse, etc.). A billing transaction may include, inter alia:

1) The appearance of a line item charge on the bill or statement that a MS receives from her WC. Exemplary mechanics and logistics associated with this approach are described in, for example, pending U.S. patent application Ser. No. 10/837,695 entitled “SYSTEM AND METHOD FOR BILLING AUGMENTATION.” Other ways of completing or performing line item billing are easily implemented by those skilled in the art.

2) The charging of a credit card or the debiting of a debit card.

3) The (electronic, etc.) transfer of funds.

4) The generation of an invoice, statement, etc.

In FIG. 3 the exchanges that are collected under the designation Set 2 represent the activities that might take place as SPₓ 304 optionally coordinates, etc. (see 336→338) with one or more external entities (such as, for example, one or more CPs) to, possibly among other things, secure access, arrange to receive updates, etc.

The specific exchanges that were described above (as residing under the designation Set 2) are illustrative only and it will be readily apparent to one of ordinary skill in the relevant art that numerous other exchanges (including, inter alia, updates to various of the information in a MS Profile in a SP's repository, etc.) are easily possible and indeed are fully within the scope of the present invention.

In FIG. 3 the exchanges that are collected under the designation Set 3 represent the activities that might take place as SPₓ 304 dispatches to Mary 302 one or more confirmation E-mail messages (see 340→342).

The specific exchanges that were described above (as residing under the designation Set 3) are illustrative only and it will be readily apparent to one of ordinary skill in the relevant art that numerous other exchanges (including, inter alia, other types or forms of confirmation messages) are easily possible and indeed are fully within the scope of the present invention.

In FIG. 3 the exchanges that are collected under the designation Set 4 represent the activities that might take place as AS 318 of SPₓ 304 dispatches one or more confirmation SMS, MMS, IMS, etc. messages to Mary's 302 WD 306 (see 344 →348) and Mary 302 replies or responds to the message(s) (see 350→354). Of interest and note are:

1) In the instant example the messages are shown traversing a MICV 312.

2) The SP 304 may employ a Short Code (SC) or a regular TN as its source address (and to which it would ask users of its service to direct any reply messages). While the abbreviated length of a SC (e.g., five digits for a SC administered by Neustar under the Common Short Code [CSC] program) incrementally enhances the experience of a MS 302 (e.g., the MS 302 need remember and enter only a few digits as the destination address of a reply message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY.”

The specific exchanges that were described above (as residing under the designation Set 4) are illustrative only and it will be readily apparent to one of ordinary skill in the relevant art that numerous other exchanges are easily possible and indeed are fully within the scope of the present invention.

The Set 1, Set 2, Set 3, and Set 4 exchanges that were described above are illustrative only and it will be readily apparent to one of ordinary skill in the relevant art that numerous other exchanges are easily possible and indeed are fully within the scope of the present invention.

The registration information that was described above may subsequently be managed (e.g., existing information may be edited or removed, new information may be added, etc.) through any combination of one or more channels including, inter alia, a SP's WWW facility, wireless messaging (SMS, MMS, IMS, etc.), e-mail messages, IM exchanges, conventional mail, telephone, IVR facilities, etc.

To continue with the explanation of key aspects of the present invention, consider one possible use or incarnation of aspects of the present invention. In this simple illustrative use Mary, our hypothetical MS, completes a registration process (e.g., as described above), subsequently enters a movie theater, observes content being displayed or presented on the movie screen, and reacts accordingly.

The simple scenario that was just described (i.e., Mary completes a registration process, enters a movie theater, observes content being displayed or presented on the movie screen, and reacts accordingly) is illustrative only and it will be readily apparent to one of ordinary skill in the art that numerous other alternative scenarios (i.e., arrangements) are easily possibly and indeed are fully within the scope of the present invention. For example:

A) The content that is displayed on the screen may consist of, possibly inter alia, advertisements, news items, traffic alerts, weather notices, coupons, informational notices, financial alerts, etc. A piece of content may request that a MS dispatch a (SMS, MMS, etc.) message to a destination address (e.g., possibly inter alia, a SC or a TN); optionally include a code, keyword, etc. in the body of the message; etc.

B) The content may be presented before a movie (such as during ‘The Twenty’ or ‘First Look’ segments at Regal Entertainment Group movie theaters), during a movie, during an intermission period, at the end of a movie, etc. C) The content may be presented on screens at venues other than movie theaters—e.g., at a presentation or symposium or conference, at a concert, in a store, at a hotel, at an airport, etc.

D) The content may be ‘keyed’ to or otherwise associated with a venue. For example, the content may be specific to the movie that a movie theater is showing, specific to the subject matter of a presentation/symposium/conference, etc.

E) The content may be static (as one possible example, fully pre-recorded), or partially or fully dynamic (as one possible example, aspects generated real-time), or a combination of both (i.e., static and dynamic).

F) The generation of dynamic content may be based on, possibly inter alia, the makeup of a venue's audience. For example:

i) A SP may become aware of the presence of registered MSs at a specific venue through any number of automatic and/or manual means. Automatic means may include, possibly inter alia, such mechanisms like Global Positioning System (GPS)/Location-Based Services (LBS), Bluetooth, etc. Manual means may include, possibly inter alia, a MS dispatching one or more (SMS, MMS, etc.) messages.

ii) From the profiles of the identified (registered) MSs a SP may review, aggregate, etc. various Preference Information elements.

iii) From the reviewed, aggregated, etc. Preference Information a SP may develop one or more ranked, rated, etc. lists of common preferences, likes, etc. The developed lists may optionally incorporate information that may be specific to a venue—e.g., attributes of the movie that a movie theater is showing, the subject matter of a presentation/symposium/conference, etc.

iv) Based on the ranked, rated, etc. lists a SP may dynamically generate content. The dynamically generated content may optionally be based on, include, leverage, be derived from, etc. various CP-supplied materials.

v) Using any number of means or channels a SP may convey the dynamically generated content to a venue (for, possibly inter alia, subsequent display, showing, etc. to members of the venue audience).

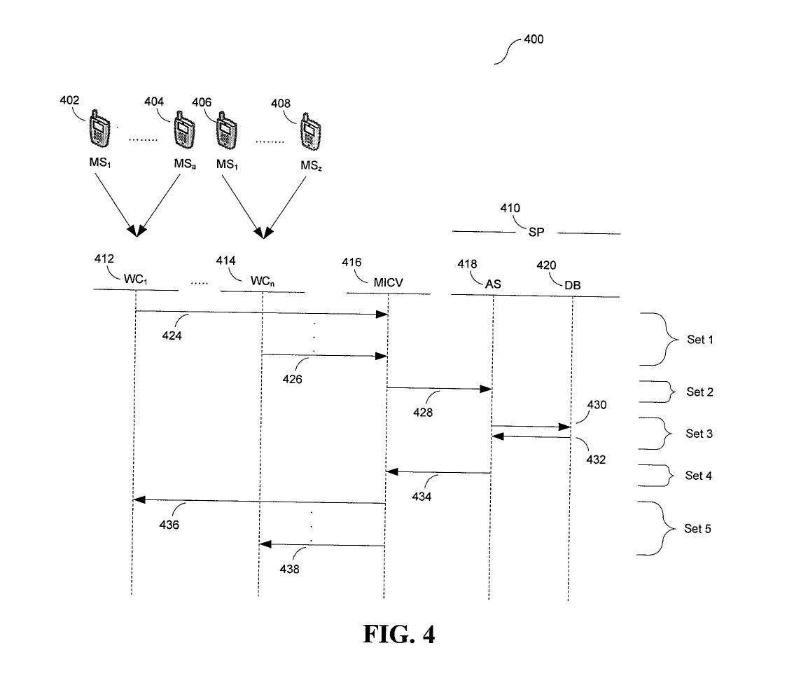

The simple scenario that was described above (i.e., Mary completes a registration process, enters a movie theater, observes content being displayed or presented on the movie screen, and reacts accordingly) may be examined further through the illustrative interactions that are depicted in FIG. 4 and reference numeral 400. Of interest and note are the following entities:

MS₁ 402→MSₐ 404 and MS₁ 406→MS_{z} 408. The WDs (such as a mobile telephones, BlackBerrys, PalmPilots, etc.) of various MS (including Mary).

WC₁ 412→WCₙ 414. Numerous WCs.

MICV 416. As noted above the use of a MICV, although not required, provides significant advantages.

SP 410 AS 418. Facilities that provide key elements of the instant invention (which will be described below).

SP 410 Database (DB) 420. One or more data repositories that are leveraged by SPₓ's 410 AS 418.

In the discussion to follow reference is made to messages that are sent, for example, between a MS 402→404/406→408 and an SP 410. As set forth below, a given “message” sent between a MS 402→404/406→408 and a SP 410 may actually comprise a series of steps in which the message is received, forwarded and routed between different entities, including a WD associated with a MS 402→404/406→408, a WC 412→414, a MICV 416, and a SP 410. Thus, unless otherwise indicated, it will be understood that reference to a particular message generally includes that particular message as conveyed at any stage between an origination source, such as a WD of a MS 402→404/406→408, and an end receiver, such as a SP 410. As such, reference to a particular message generally includes a series of related communications between, for example, a MS 402→404/406→408 and a WC 412→414, the WC 412→414 and a MICV 416, and the MICV 416 and a SP 410. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

In FIG. 4 the exchanges that are collected under the designation Set 1 and Set 2 represent the activities that might take place as the (SMS, MMS, etc.) messages that are dispatched by Mary (MS₁ 402→MSₐ 404 and MS₁ 406→MS_{z} 408), in response to content that Mary (MS₁ 402→MSₐ 404 and MS₁ 406→MS_{z} 408) has observed, are routed by the various WCs (WC₁ 412→WCₙ 414) to a MICV 416 (see 424→426) and then directed, by the MICV 416, to SPₓ410 (see 428).

It is important to note the Set 1 and Set 2 exchanges are illustrative only and it will be readily apparent to one of ordinary skill in the relevant art that numerous other exchanges are easily possible and indeed are fully within the scope of the present invention.

In FIG. 4 the exchanges that are collected under the designation Set 3, Set 4, and Set 5 represent the activities that might take place as the (SMS, MMS, etc.) messages are processed by SPₓ 410 (specifically, by an AS 418 of SPₓ 410). To provide context for our review of the Set 3, Set 4, and Set 5 exchanges we take a brief detour to describe an illustrative SP 410 AS 418.

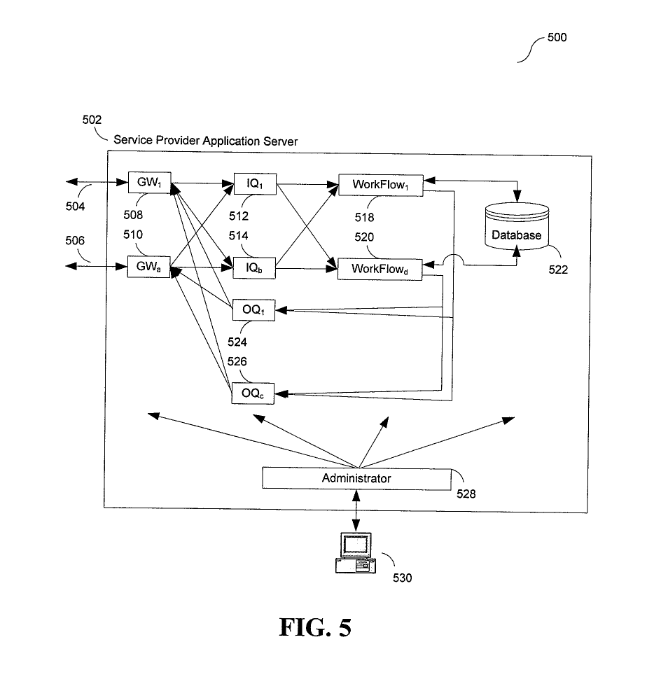

FIG. 5 and reference numeral 500 provide a diagrammatic presentation of aspects of an exemplary SP AS 502. The illustrated AS 502 contains several key components—Gateways (GW₁ 508→GWₐ 510 in the diagram), Incoming Queues (IQ₁ 512→IQ_{b} 514 in the diagram), WorkFlows (WorkFlow₁ 518→WorkFlow_{d} 520 in the diagram), Database 522, Outgoing Queues (OQ₁ 524→OQ_{c} 526 in the diagram), and an Administrator 528. It will be readily apparent to one of ordinary skill in the relevant art that numerous other components are possible within an AS 502.

A dynamically updateable set of one or more Gateways (GW₁ 508→GWₐ 510 in the diagram) handle incoming (SMS/MMS/IMS/etc. messaging, etc.) traffic 504→506 and outgoing (SMS/MMS/IMS/etc. messaging, etc.) traffic 504→506. Incoming traffic 504→506 is accepted and deposited on an intermediate or temporary Incoming Queue (IQ₁ 512→IQ_{b} 514 in the diagram) for subsequent processing. Processed artifacts are removed from an intermediate or temporary Outgoing Queue (OQ₁ 524→OQ_{c} 526 in the diagram) and then dispatched 504→506.

A dynamically updateable set of one or more Incoming Queues (IQ₁ 512→IQ_{b} 514 in the diagram) and a dynamically updateable set of one or more Outgoing Queues (OQ₁ 524→OQ_{c} 526 in the diagram) operate as intermediate or temporary buffers for incoming and outgoing traffic 504→506.

A dynamically updateable set of one or more WorkFlows (WorkFlow₁ 518→WorkFlow_{d} 520 in the diagram) remove incoming traffic 504→506 from an intermediate or temporary Incoming Queue (IQ₁ 512→IQ_{b} 514 in the diagram), perform all of the required processing operations (explained below), and deposit processed artifacts on an intermediate or temporary Outgoing Queue (OQ₁ 524→OQ_{c} 526 in the diagram). The WorkFlow component will be described more fully below.

The Database 522 that is depicted in FIG. 5 is a logical representation of the possibly multiple physical repositories that may be implemented to support, inter alia, configuration, word catalog, calculation, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

An Administrator 528 provides management or administrative control over all of the different components of an AS 502 through, as one example, a WWW-based interface 530. It will be readily apparent to one of ordinary skill in the relevant art that numerous other interfaces (e.g., an Application Programming Interface [API], a data feed, etc.) are easily possible.

Through flexible, extensible, and dynamically updatable configuration information a WorkFlow component may be quickly and easily realized to support any number of activities. For example, WorkFlows might be configured to support an optional registration process; to support the receipt and processing of incoming (SMS, MMS, IMS, etc.) messages; to support the scanning of the body or content of a received message; to support the generation and dispatch of content; to support the generation and dispatch of outgoing confirmation, update, etc. messages; to support the generation of scheduled and/or on-demand reports; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, messaging, processing, etc. activities may be recorded. Among other things, such a repository may be used to support:

1) Scheduled (e.g., daily, weekly, etc.) and/or on-demand reporting with report results delivered through SMS, MMS, IMS, etc. messages; through E-mail; through a WWW-based facility; through IM; through an IVR facility; etc.

2) Scheduled and/or on-demand data mining initiatives (possibly leveraging or otherwise incorporating one or more external data sources) with the results of same presented through visualization, Geographic Information System (GIS), etc. facilities and delivered through SMS, MMS, IMS, etc. messages; through E-mail; through a WWW-based facility; trough IM; through an IVR facility; etc.

Generated reports may contain, possibly inter alia, textual and graphic elements.

Over time as ever more messages are presented to a SP the SP may continuously expand the depth and/or the breadth of its internal repositories and, possibly inter alia, consequently incrementally refine, improve, etc. the quality, etc. of its message review, reporting, etc. activities.

Returning to FIG. 4 . . . the processing activities that are depicted under the designation Set 3, Set 4, and Set 5 might include, possibly inter alia (see, for example, 430→438):

A) Retrieving an incoming message from an IQ.

B) Extracting from a received message, and optionally validating/etc., various data elements including, inter alia, the Source Address (SA, such as, for example, the source TN), the Destination Address (such as, for example, the destination TN), the message content or body (that might contain, as just one possible example, a code or keyword), etc.

C) Preserving various elements of the received message in a Messages database table.

D) Updating a MS database table, as appropriate and as required, to ensure that an entry exists for the SA (such as, for example, the TN) of the message.

E) Performing one or more analytical steps. The analytical steps may be realized through a combination of, possibly inter alia:

i) Flexible, extensible, and dynamically configurable Workflows (as previously described) that implement the rules, logic, etc. for a range of message handling methods (including, inter alia, statistical, pattern matching, stylistic, linguistic, heuristic, etc.).

ii) Dynamically updateable internal and/or external data sources (including, possibly inter alia, word catalogs, etc.).

and may, possibly among other things, optionally score, rate, rank, etc. the developed results; optionally augment the developed results with internal and/or external demographic, geographic, etc. data; etc.

F) Generating one or more indicators. Indicators may capture, inter alia, specific characteristics, patterns, traits, features, MS requests, etc.

G) Preserving one or more of the generated indicators in an Indicators database table.

H) Leveraging a flexible, extensible, and dynamically configurable list of defined events (e.g, as maintained in an EventDefinitions database table) to generate one or more events. Events may include, inter alia, alerting one or more parties (such as, for example, a MS, a WC, a MICV, a CP, etc.) through any combination of one or more channels such as SMS/MMS/etc. messages, E-mail messages, IM messages, data feeds; optionally responding to a MS (through, as just one example, a reply SMS/MMS/etc. message); optionally dynamically updating one or more data repositories; etc.

I) Preserving one or more of the generated events in an Events database table.

J) Depositing, consistent with the generated indicator(s) and event(s), one or more outgoing messages on an OQ.

The catalog of processing steps that were described above are illustrative only and it will be readily apparent to one of ordinary skill in the relevant art that numerous other processing steps (such as, possibly inter alia, scoring, ranking, rating, etc. one or more of the generated indicators) are easily possible and indeed are fully within the scope of the present invention. For example:

1) An incoming (SMS, MMS, etc.) message may optionally result in one or more outgoing (SMS, MMS, etc.) confirmation, notification, etc. messages (to, for example, a MS; one or more representatives of a MICV, a WC, a CP; etc.).

2) Various of the elements that were described above might optionally be made WC-specific, MICV-specific, CP-specific, etc.

A SP may optionally offer one or more of the processing steps, reporting capabilities, etc. that were described above as value-add services for which, possibly inter alia, a SP may charge a fee. The processing, capture, etc. of such a fee may be handled by a SP's BI.

It is important to note the exchanges that were described above (as residing under the designation Set 3, Set 4, and Set 5 in FIG. 4) are illustrative only and it will be readily apparent to one of ordinary skill in the relevant art that numerous other exchanges are easily possible and indeed are fully within the scope of the present invention.

The simple scenario that was described above (i.e., Mary completes a registration process, enters a movie theater, observes content being displayed or presented on the movie screen, and reacts accordingly) is illustrative only and it will be readily apparent to one of ordinary skill in the relevant art that numerous other arrangements are easily possible and indeed are fully within the scope of the present invention. For example:

1) A MS′ dispatch of a SMS/MMS/etc. message (in response to, and according to the instructions that were contained within, what the MS observed on a screen) may result in a SP interacting, coordinating, etc. with one or more CPs. The interacting, coordinating, etc. may result in, possibly inter alia, a MS receiving (immediately, at some point in the future, etc.) one or more pieces of content from a CP, a MS receiving (immediately, at some point in the future, etc.) one or more (SMS, MMS, etc.) confirmation, informational, etc. messages from a CP, a MS being enrolled for a drawing or a contest, a MS being contacted by a representative of a CP, etc.

2) A SP may be alerted to the end of a movie through any number of automatic (e.g., by a movie theater, via location changes detected by GPS/LBS, etc.) and/or manual (e.g., via the dispatch of a message by a MS) mechanisms. Once so alerted a SP may dispatch to a MS one or more (SMS, MMS, etc.) content messages containing (as just a few of the many possibilities) coupons, advertisements, directions to a local restaurant, traffic updates (e.g., as retrieved from a Transport Protocol Experts Group (TPEG) compliant mechanism), weather alerts, etc.

3) Should a MS act on a received message—e.g., redeem a coupon, visit a restaurant, etc. —a SP may optionally, possibly inter alia:

i) Track that action.

ii) Receive (solicited and/or unsolicited) feedback, information, etc. from an end vendor (such as, for example, a restaurant, a store, etc.).

iii) Allocate to a MS some number of points, credits, money, etc.

iv) Dispatch to the MS one or more (SMS, MMS, etc.) update, etc. messages.

v) Update one or more data repositories to memorialize aspects of the above.

4) A SP may optionally allow a MS to redeem, collect, etc. their accumulated points/credits/money/etc. through any number of channels including, possibly inter alia, a MS′ WC (e.g., by communicating, interacting, etc. with the MS′ WC to, possibly inter alia, facilitate the MS receiving their accumulated points/credits/cash/etc. on the MS′ monthly statement), a WWW site, E-mail, postal mail, etc.

The various confirmation, content, update, report, etc. message(s) that were described above may optionally contain an informational element—e.g., a service announcement, a relevant or applicable factoid, etc. The informational element may be selected statically (e.g., all generated messages are injected with the same informational text), selected randomly (e.g., a generated message is injected with informational text that is randomly selected from a pool of available informational text), or selected based on location (i.e., a generated message is injected with informational text that is selected from a pool of available informational text based on the current physical location of the recipient of the message as derived from, as one example, a LBS/GPS facility).

A SP may optionally allow advertisers to register and/or provide (e.g., directly, or through links/references to external sources) advertising content.

The provided advertising content may optionally be included in various of the above described message(s)—e.g., textual material, multimedia (images of brand logos, sound, video snippets, etc.) material, etc. The advertising material may be selected statically (e.g., all generated messages are injected with the same advertising material), selected randomly (e.g., a generated message is injected with advertising material that is randomly selected from a pool of available material), or selected based on location (i.e., a generated message is injected with advertising material that is selected from a pool of available material based on the current physical location of the recipient of the message as derived from, as one example, a LBS/GPS facility).

The above described message(s) may optionally contain promotional materials, coupons, etc. (via, possibly inter alia, text, still images, video clips, etc.).

It is important to note that while aspects of the discussion that was presented above focused on the use of SCs and TNs it will be readily apparent to one of ordinary skill in the relevant art that other message address identifiers are equally applicable and, indeed, are fully within the scope of the present invention.

The discussion that was just presented referenced the specific wireless messaging paradigms SMS and MMS. However, it is to be understood that it would be readily apparent to one of ordinary skill in the relevant art that other messaging paradigms (IMS, WAP, E-mail, etc.) are fully within the scope of the present invention.

It is important to note that the hypothetical example that was presented above, which was described in the narrative and which was illustrated in the accompanying figures, is exemplary only. It is not intended to be exhaustive or to limit the invention to the specific forms disclosed. It will be readily apparent to one of ordinary skill in the relevant art that numerous alternatives to the presented example are easily possible and, indeed, are fully within the scope of the present invention.

The following list defines acronyms as used in this disclosure.

| Acronym | Meaning |
|---|---|
| API | Application Programming Interface |
| AS | Application Server |
| BI | Billing Interface |
| CP | Content Provider |
| CSC | Common Short Code |
| DB | Database |
| DBMS | Database Management System |
| E-mail | Electronic Mail |
| GIS | Geographic Information System |
| GPS | Global Positioning System |
| GW | Gateway |
| IM | Instant Messaging |
| IMS | IP Multimedia Subsystem |
| IP | Internet Protocol |
| IQ | Incoming Queue |
| IVR | Interactive Voice Response |
| LBS | Location Based Services |
| MICV | Messaging Inter-Carrier Vendor |
| MMS | Multimedia Message Service |
| MS | Mobile Subscriber |
| ODBMS | Object Database Management System |
| OQ | Outgoing Queue |
| PC | Personal Computer |
| RDBMS | Relational Database Management System |
| SA | Source Address |
| SC | Short Code |
| SMS | Short Message Service |
| SP | Service Provider |
| TN | Telephone Number |
| TPEG | Transport Protocol Experts Group |
| WAP | Wireless Application Protocol |
| WC | Wireless Carrier |
| WD | Wireless Device |
| WS | Web Server |
| WWW | World Wide Web |

What is claimed is:

1. A method for distributing content within a wireless ecosystem, comprising:
receiving an incoming message from a mobile subscriber, said incoming message being responsive to content viewed by said mobile subscriber;
ascertaining a location of said mobile subscriber;
performing one or more processing steps on the incoming message using, at least in part, information previously supplied by the mobile subscriber and the location of said mobile subscriber;
generating and dispatching to said mobile subscriber one or more outgoing messages based, at least in part, on the location of said mobile subscriber and content associated with the location of said mobile subscriber.

2. The method of claim 1, wherein an incoming message is one of (a) a short message service message, (b) a multimedia message service message, and/or (c) an IP multimedia subsystem message.

3. The method of claim 1, wherein the viewed content is dynamically changing content.

4. The method of claim 3, wherein the dynamically changing content is changed based, at least in part, on characteristics of other mobile subscribers at the same location as the location of said mobile subscriber.

5. The method of claim 1, wherein an outgoing message is one of (a) a short message service message, (b) a multimedia message service message, and/or (c) an IP multimedia subsystem message.

6. The method of claim 1, wherein an outgoing message contains one or more of (a) informational text, (b) an advertisement, (c) a coupon, and/or (d) content.

7. The method of claim 1, further comprising:
receiving confirmation that said mobile subscriber acted upon contents of said outgoing message;
performing one or more processing steps on the received confirmation, including at least updating a tracking repository; and
generating and dispatching to said mobile subscriber one or more update messages.

8. The method of claim 7, wherein the tracking repository maintains, for each mobile subscriber, counts of one or more of accumulated (a) points, (b) credits, and/or (c) money.

9. The method of claim 7, wherein an update message is one or more of (a) a short message service message, (b) a multimedia message service message, and/or an IP multimedia subsystem message.

10. The method of claim 7, further comprising:
receiving a redemption request from said mobile subscriber;
performing one or more processing steps on the received redemption request including at least the updating of said tracking repository; and
redeeming some portion of accumulated value to said mobile subscriber based at least in part on counts belonging to said mobile subscriber in said tracking repository.

11. The method of claim 10, wherein said redemption takes place through one or more of (a) a wireless carrier, (b) a world wide web site, (c) electronic mail, and/or (d) postal mail.

12. The method of claim 1, wherein said information is defined by a mobile subscriber during a registration process.

13. The method of claim 12, wherein said information includes one or more of Identifying Information, Notification Information, Billing Information, and Preference Information.

14. The method of claim 12, wherein said information is preserved through a User Profile.

15. The method of claim 12, wherein said registration process is Web-based.

16. The method of claim 12, wherein said registration process includes a billing component.

17. A method for interacting with wireless mobile subscribers, comprising:
receiving a first message from a first mobile subscriber;
determining that said first mobile subscriber is present at a predetermined venue;
delivering first content from a content provider to said first mobile subscriber, wherein the first content is associated with the predetermined venue;
receiving a reply message from said first mobile subscriber in response to said first content;
receiving a second message from a second mobile subscriber;
determining that said second mobile subscriber is also present at the predetermined venue;
delivering second content from the content provider to the said second mobile subscriber, wherein the second content is different from the first content and is selected based, at least in part, on contents of the reply message from said first mobile subscriber.

18. The method of claim 17, further comprising selecting the content based on information previously received during a registration process from both said first and said second mobile subscribers.

19. The method of claim 17, further comprising communicating with the content provider in response to, at least, the reply message and the second message from said second mobile subscriber.

20. The method of claim 17, further comprising delivering the first and the second content at a moment in time that coincides with a time of a predetermined event at the predetermined venue.
